(19) United States
(12) Patent Application Publication
(10) Pub. No.: US 2024/0332926 A1
(43) Pub. Date: Oct. 3, 2024

(54) METHOD FOR LAYING SUBMARINE CABLE SYSTEM

(71) Applicant: NEC Corporation, Tokyo (JP)

(72) Inventor: Yoshinari TAKIGAWA, Tokyo (JP)

(73) Assignee: NEC Corporation, Tokyo (JP)

(21) Appl. No.: 18/410,362

(22) Filed: Jan. 11, 2024

(30) Foreign Application Priority Data
Mar. 30, 2023 (JP) 2023-054974

(51) Int. Cl. H02G 1/10

(52) U.S. Cl. CPC H02G 1/10

(57) ABSTRACT

A method for laying a submarine cable system in which the construction of the submarine cable system is highly adaptable is provided. A method for laying a submarine cable system according to the present disclosure includes: laying a first trunk submarine cable comprising a branching apparatus to which a branch submarine cable is not connected at a bottom of the sea; laying a second trunk submarine cable comprising a branching apparatus to which the branch submarine cable is not connected at the bottom of the sea; connecting one end of a branch submarine cable to the branching apparatus included in the first trunk submarine cable; and connecting an other end of the branch submarine cable to the branching apparatus included in the second trunk submarine cable.

### INCORPORATION BY REFERENCE

This application is based upon and claims the benefit of priority from Japanese patent application No. 2023-054974, filed on Mar. 30, 2023, the disclosure of which is incorporated herein in its entirety by reference.

### TECHNICAL FIELD

The present disclosure relates to a method for laying a submarine cable system.

### BACKGROUND ART

Japanese Unexamined Patent Application Publication No. 2021-197735 discloses a switching branching unit inserted into a trunk submarine cable. A submarine branch cable is connected to the switching branching unit disclosed in Japanese Unexamined Patent Application Publication No. 2021-197735, and the submarine branch cable connects two types of trunk submarine cables to each other.

Incidentally, when a first submarine cable connecting two land stations to each other and a second submarine cable connecting two other land stations to each other are laid, there may be a demand that communication be performed between the two land stations connected to the first submarine cable and the two land stations connected to the second submarine cable due to factors such as a change in communication demand after the completion of the laying of the submarine cables.

However, in the technology disclosed in Japanese Unexamined Patent Application Publication No. 2021-197735, the connection relation between the submarine cables cannot be changed after the completion of the laying of the submarine cables, and thus the above demand cannot be satisfied. That is, in the technology disclosed in Japanese Unexamined Patent Application Publication No. 2021-197735, there is a problem that the construction of the submarine cable system is not sufficiently adaptable.

### SUMMARY

The present disclosure has been made to solve the above-described problem, and an object thereof is to provide a method for laying a submarine cable system in which the construction of the submarine cable system is highly adaptable.

A method for laying a submarine cable system according to one example aspect of the present disclosure includes:
laying a first trunk submarine cable and a second trunk submarine cable at a bottom of the sea, each of the first and the second trunk submarine cables comprising a branching apparatus to which a branch submarine cable is not connected;
connecting one end of the branch submarine cable to the branching apparatus included in the first trunk submarine cable; and
connecting an other end of the branch submarine cable to the branching apparatus included in the second trunk submarine cable.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a schematic overhead view showing a configuration example of a submarine cable system according to the present disclosure;

FIG. 2 is a flowchart showing a method for laying the submarine cable system according to the present disclosure;

FIG. 3 is a schematic overhead view showing a configuration example of another submarine cable system according to the present disclosure;

FIG. 4 is a schematic circuit diagram showing a configuration example of a branching apparatus according to the present disclosure;

FIG. 5 is a schematic circuit diagram showing a configuration example of the branching apparatus according to the present disclosure;

FIG. 6 is a schematic circuit diagram showing a configuration example of the branching apparatus according to the present disclosure;

FIG. 7 is a block diagram showing a configuration example of a land station according to the present disclosure;

FIG. 8 is a flowchart showing a method for laying a submarine cable system according to the present disclosure; and

FIG. 9 is a schematic overhead view showing another configuration example of a submarine cable system according to the present disclosure.

### EXAMPLE EMBODIMENT

### First Example Embodiment

### <Configuration of a Submarine Cable System>

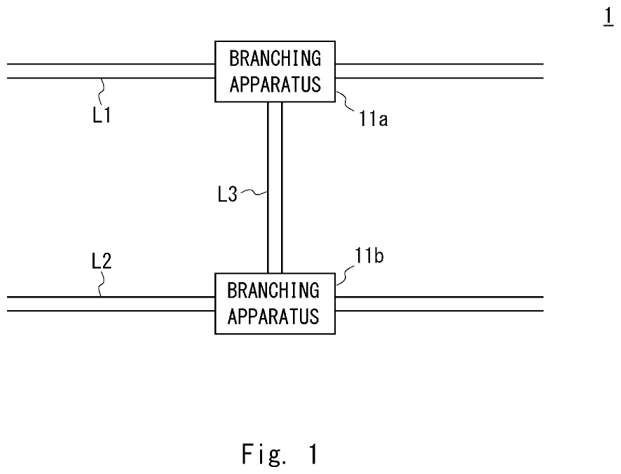

A configuration of a submarine cable system 1 laid by a method for laying a submarine cable will be described in detail with reference to FIG. 1.

FIG. 1 is a schematic overhead view showing a configuration example of the submarine cable system according to the present disclosure.

The submarine cable system 1 laid by the method for laying a submarine cable according to this example embodiment includes a first trunk submarine cable L1, a second trunk submarine cable L2, a branch submarine cable L3, a branching apparatus 11a, and a branching apparatus 11b.

The first trunk submarine cable L1 is a trunk submarine cable including the branching apparatus 11a.

The first trunk submarine cable L1 is connected to the branch submarine cable L3 through the branching apparatus 11a. In other words, the branch submarine cable L3 is branched from the first trunk submarine cable L1 by the branching apparatus 11a.

The second trunk submarine cable L2 is a trunk submarine cable including the branching apparatus 11b.

The second trunk submarine cable L2 is connected to the branch submarine cable L3 through the branching apparatus 11b. In other words, the branch submarine cable L3 is branched from the second trunk submarine cable L2 by the branching apparatus 11b.

The branching apparatus 11a is a branching apparatus inserted into the first trunk submarine cable L1. The branching apparatus 11a is connected to one end of the branch submarine cable L3. The branching apparatus 11a connects the first trunk submarine cable L1 to the branch submarine cable L3.

That is, the branching apparatus 11a branches the branch submarine cable L3 from the first trunk submarine cable L1.

The branching apparatus 11b is a branching apparatus inserted into the second trunk submarine cable L2. The branching apparatus 11b is connected to the other end of the branch submarine cable L3. The branching apparatus 11b connects the second trunk submarine cable L2 to the branch submarine cable L3.

That is, the branching apparatus 11b branches the branch submarine cable L3 from the second trunk submarine cable L2.

One end of the branch submarine cable L3 is connected to the branching apparatus 11a and the other end thereof is connected to the branching apparatus 11b. The branch submarine cable L3 connects the first trunk submarine cable L1 and the second trunk submarine cable L2 to each other.

### <Method for Laying a Submarine Cable System>

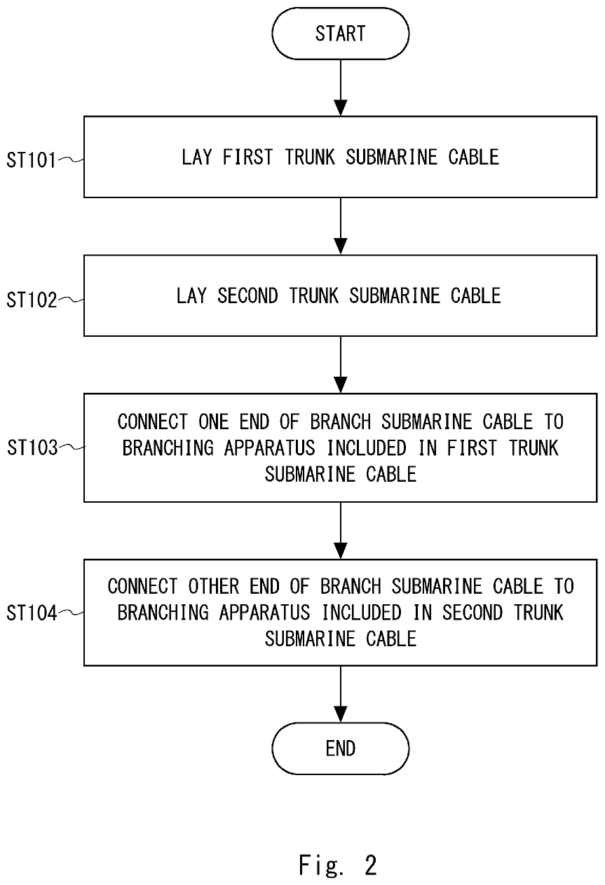

Next, the method for laying a submarine cable according to this example embodiment will be described with reference to FIG. 2. Note that in the following description, FIG. 1 is also referred to as appropriate.

First, the first trunk submarine cable L1 is laid (Step ST101). Next, the second trunk submarine cable L2 is laid (Step ST102).

Note that the order in which Steps ST101 and ST102 are executed may be reversed. Further, Steps ST101 and ST102 may be executed in parallel.

Next, one end of the branch submarine cable L3 is connected to the branching apparatus 11a included in the first trunk submarine cable L1 (Step ST103).

Lastly, the other end of the branch submarine cable L3 is connected to the branching apparatus 11b included in the second trunk submarine cable L1 (Step ST104). In this way, the method for laying a submarine cable according to this example embodiment is completed.

As described above, in the method for laying a submarine cable system according to this example embodiment, the first and the second trunk submarine cables, each of which includes a branching apparatus, are laid, and then a branch submarine cable is connected to the branching apparatuses.

According to the above method for laying a submarine cable system, trunk submarine cables to be connected to each other can be changed as appropriate in response to a change in communication demand, and thus the construction of the submarine cable system can be made to be more adaptable.

### Second Example Embodiment

### <Configuration of a Submarine Cable System>

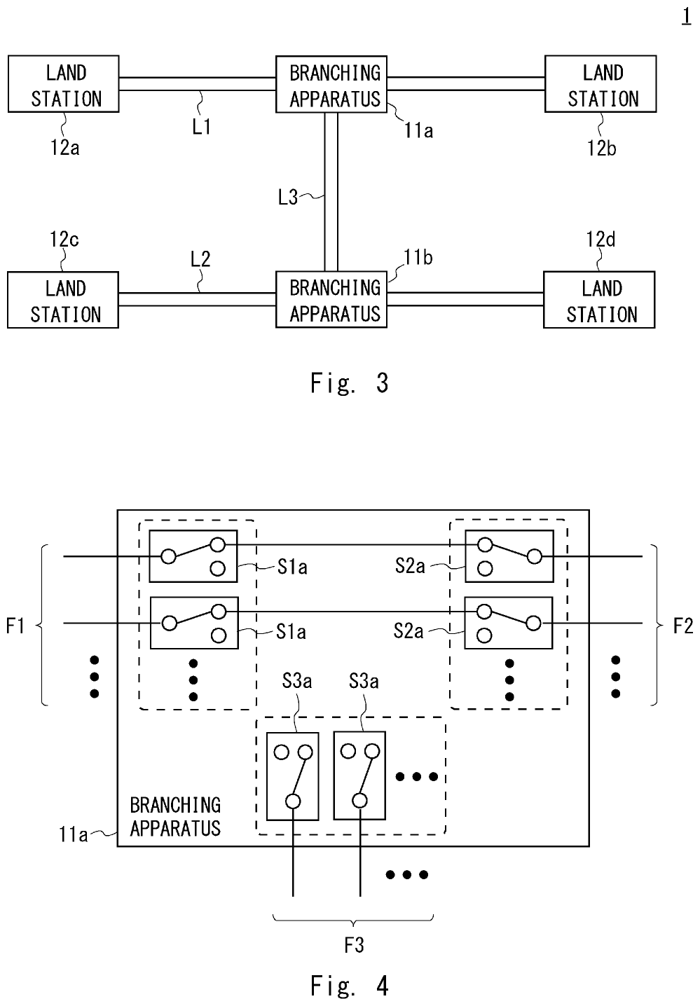

A configuration of the submarine cable system 1 laid by a method for laying a submarine cable will be described in detail with reference to FIG. 3. FIG. 3 is a schematic overhead view showing another configuration example of the submarine cable system according to the present disclosure.

In the submarine cable system 1 according to this example embodiment, two types of trunk submarine cables are connected to each other by a branch submarine cable.

The submarine cable system 1 according to this example embodiment includes land stations 12a to 12d, the branching apparatuses 11a and 11b, the trunk submarine cables L1 and L2, and the branch submarine cable L3.

Both ends of each of the trunk submarine cables L1 and L2 are connected to the land stations. One end of the first trunk submarine cable L1 is connected to the land station 12a and the other end thereof is connected to the land station 12b. Further, one end of the second trunk submarine cable L2 is connected to the land station 12c and the other end thereof is connected to the land station 12d.

The branching apparatus 11a is inserted into the trunk submarine cable L1 and the branching apparatus 11b is inserted into the trunk submarine cable L2. Further, relay apparatuses (not shown) are inserted into the trunk submarine cables L1 and L2 as necessary and appropriate.

The trunk submarine cable L1 is connected to one end of the branch submarine cable L3 through the branching apparatus 11a. Further, the trunk submarine cable L2 is connected to the other end of the branch submarine cable L3 through the branching apparatus 11b. That is, the trunk submarine cables L1 and L2 are connected to each other by the branch submarine cable L3.

The trunk submarine cables L1 and L2 includes optical fiber transmission lines for transmitting optical signals. The optical fiber transmission line included in each trunk submarine cables L1 and L2 is formed of fiber pairs, each of which is a pair of two optical fibers. The optical fiber transmission line included in each trunk submarine cables L1 and L2 includes a plurality of fiber pairs.

Two optical fibers forming one fiber pair connect between the same two land stations, and the directions of the transmission and reception of signals in the two optical fibers are opposite to each other. For example, when the fiber pair connects the land station 12a to the land station 12b, one of the optical fibers forming the fiber pair transmits an optical signal transmitted from the land station 12a to the land station 12b. Further, the other of the optical fibers forming the fiber pair transmits an optical signal transmitted from the land station 12b to the land station 12a.

The fiber pair included in the trunk submarine cable L1 is connected to the fiber pair included the branch submarine cable L3 inside the branching apparatus 11a as necessary and appropriate. Further, the fiber pair included in the trunk submarine cable L2 is connected to the optical fiber included in the branch submarine cable L3 inside the branching apparatus 11b as necessary and appropriate.

Note that the trunk submarine cable L1 is configured so that communication between the land station 12a and the land station 12b can be performed even when the branch submarine cable L3 is not being connected thereto.

Further, the trunk submarine cable L2 is configured so that communication between the land station 12c and the land station 12d can be performed even when the branch submarine cable L3 is not being connected thereto.

That is, the trunk submarine cables L1 and L2 are configured to function as two types of trunk submarine cables independent of each other when the branch submarine cable L3 is not connected thereto.

One end of the branch submarine cable L3 is connected to the branching apparatus 11a and the other end thereof is connected to the branching apparatus 11b. In other words, the branch submarine cable L3 is branched from the trunk submarine cable L1 by the branching apparatus 11a and from the trunk submarine cable L2 by the branching apparatus 11b.

More specifically, one end of the branch submarine cable L3 is connected to an end of a submarine cable for connection provided in the branching apparatus 11a, and the other end thereof is connected to an end of a submarine cable for connection provided in the branching apparatus 11b. The submarine cable for connection will be described later.

The branch submarine cable L3 includes an optical fiber transmission line for transmitting optical signals. The optical fiber transmission line included in the branch submarine cable L3 is formed of a fiber pair, which is a pair of two optical fibers. The optical fiber transmission line provided in the branch submarine cable L3 includes a plurality of fiber pairs.

The fiber pair included in the branch submarine cable L3 is connected to the fiber pair included in the trunk submarine cable L1 through the branching apparatus 11a as necessary and appropriate. Further, the fiber pair included in the branch submarine cable L3 is connected to the optical fiber included in the trunk submarine cable L2 through the branching apparatus 11b as necessary and appropriate.

That is, the optical fiber transmission line included in the trunk submarine cable L1 and the optical fiber transmission line included in the trunk submarine cable L2 are connected to each other through the branch submarine cable L3.

By this configuration, communication can be performed between the land stations connected to the trunk submarine cable L1, that is, between the land stations 12a and 12b, and between the land stations connected to the trunk submarine cable L2, that is, between the land stations 12c and 12d.

The branching apparatus 11a is a branching apparatus inserted into the trunk submarine cable L1. The branching apparatus 11a branches the branch submarine cable L3 from the trunk submarine cable L1.

The branching apparatus 11b is a branching apparatus inserted into the trunk submarine cable L2. The branching apparatus 11b branches the branch submarine cable L3 from the trunk submarine cable L2.

The branching apparatuses 11a and 11b according to this example embodiment includes a submarine cable for connection (not shown). One end of the submarine cable for connection is connected to main bodies of the branching apparatuses 11a and 11b and the other end thereof is connected to the branch submarine cable L3. The length of the submarine cable for connection is not limited to a particular length, and may be, for example, about one to 10 kilometers.

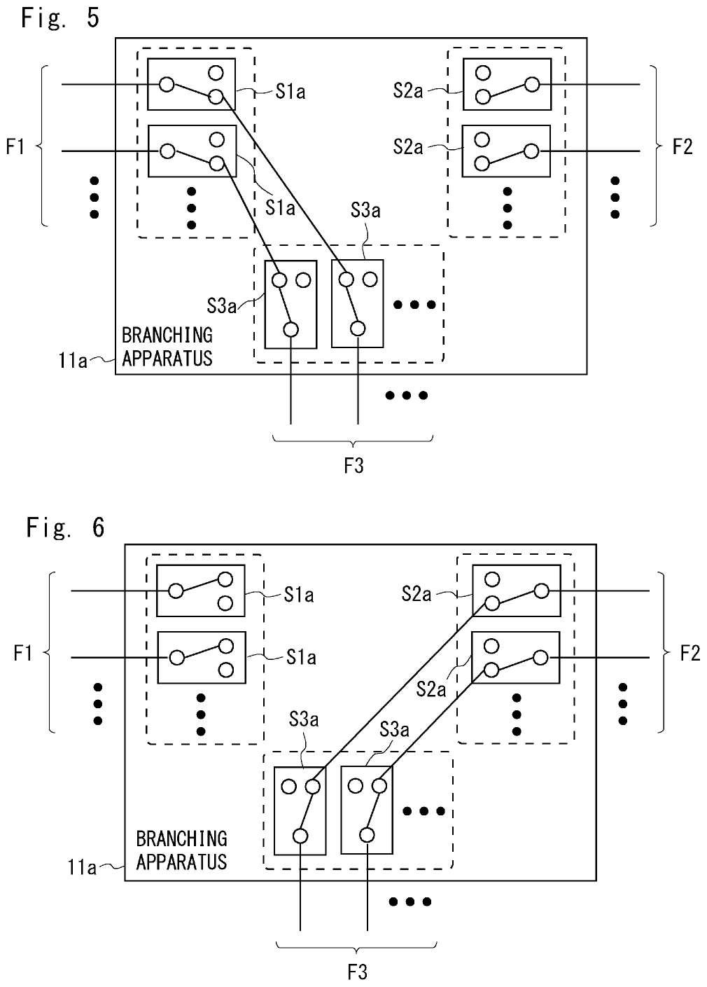

Each of FIGS. 4 to 6 is a schematic circuit diagram showing a configuration example of the branching apparatus 11a. Note that a configuration of the branching apparatus 11b is similar to that of the branching apparatus 11a.

The branching apparatus 11a according to this example embodiment includes a first switch circuit S1a connected to one side of the trunk submarine cable L1, a second switch circuit S2a connected to the other side of the trunk submarine cable L1, and a third switch circuit S3a connected to the branch submarine cable L3 through the submarine cable for connection.

Each of the switch circuits Sla to S3a is switchably connected to one of the two other switch circuits.

More specifically, the switch circuit S1a is connected to an optical fiber F1 extending from the land station 12a side among the optical fibers included in the trunk submarine cable L1. Note that the branching apparatus 11a includes a plurality of switch circuits Sla. More specifically, the number of switch circuits Sla included in the branching apparatus 11a is the same as the number of optical fibers F1 included in the trunk submarine cable L1. Each of the switch circuits Sla is connected to either the switch circuit S2a or the switch circuit S3a based on control performed by the land station 12a.

Note that the percentages of the switch circuit S1a connected to the switch circuit S2a and the switch circuit S1a connected to the switch circuit S3a are controlled by the land station 12a or 12b.

Further, the switch circuit S2a is connected to an optical fiber F2 extending from the land station 12b side among the optical fibers included in the trunk submarine cable L1. Note that the branching apparatus 11a includes a plurality of switch circuits S2a. More specifically, the number of switch circuits S2a included in the branching apparatus 11a is the same as the number of optical fibers F2 included in the trunk submarine cable L1. Each of the switch circuits S2a is connected to either the switch circuit S1a or the switch circuit S3a based on control performed by the land station 12a.

Note that the percentages of the switch circuit S2a connected to the switch circuit S1a and the switch circuit S2a connected to the switch circuit S3a are controlled by the land station 12a or 12b.

Further, the switch circuit S3a is connected to an optical fiber F3 that is included in the optical fiber included in the branch submarine cable L3 through the submarine cable for connection. Note that the branching apparatus 11a includes a plurality of switch circuits S3a. More specifically, the number of switch circuits S3a included in the branching apparatus 11a is the same as the number of optical fibers F3 included in the branch submarine cable L3. Each of the switch circuits S3a is connected to either the switch circuit S1a or the switch circuit S2a based on control performed by the land station 12a.

Note that the percentages of the switch circuit S3a connected to the switch circuit S1a and the switch circuit S3a connected to the switch circuit S2a are controlled by the land station 12a or 12b.

For example, in the branching apparatus 11a shown in FIG. 4, the switch circuit S1a and the switch circuit S2a are connected to each other.

In this case, the land station 12a is connected to the land station 12b through the optical fibers F1 and F2 shown in FIG. 4.

Further, for example, in the branching apparatus 11a shown in FIG. 5, the switch circuit S1a and the switch circuit S3a are connected to each other.

In this case, the land station 12a is connected to the land station 12c or the land station 12d through the optical fibers F1 and F3 shown in FIG. 5.

Further, for example, in the branching apparatus 11a shown in FIG. 6, the switch circuit S2a and the switch circuit S3a are connected to each other. In this case, the land station 12b is connected to the land station 12c or the land station 12d through the optical fibers F2 and F3 shown in FIG. 6.

Note that the branching apparatuses 11a and 11b according to this example embodiment are configured to function even when the branch submarine cable L3 is not being connected thereto.

When the branch submarine cable L3 is not connected to the branching apparatuses 11a and 11b, all the switch circuits Sla may be connected to the switch circuits S2a. Further, in this case, all the switch circuits S2a may be connected to the switch circuits Sla. That is, in this case, the switch circuits Sla and S2a may not be connected to the switch circuits S3a.

Referring again to FIG. 3, the explanation will be continued.

The land stations 12a to 12d communicate with each other through the trunk submarine cables L1 and L2 and the branch submarine cable L3.

More specifically, when the land stations 12a and 12b communicate with each other, they communicate with each other through the first trunk submarine cable L1. Further, when the land stations 12c and 12d communicate with each other, they communicate with each other through the second trunk submarine cable L2.

Further, when the land station 12a or 12b and the land station 12c or 12d communicate with each other, they communicate with each other through all of the first trunk submarine cable L1, the second trunk submarine cable L2, and the branch submarine cable L3.

That is, when the land station connected to the first trunk submarine cable L1 and the land station connected to the second trunk submarine cable L2 communicate with each other, they communicate with each other through the branch submarine cable L3.

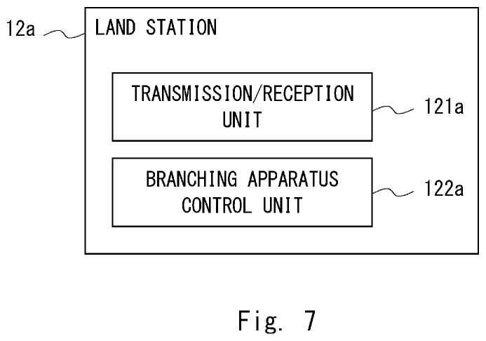

FIG. 7 is a block diagram showing a configuration example of the land station 12a. The land station 12a includes a transmission/reception unit 121a and a branching apparatus control unit 122a.

Note that a configuration of each of other land stations 12b to 12d is similar to that of the land station 12a.

The transmission/reception unit 121a converts information transmitted to the other land stations 12b to 12c into an optical signal and outputs it to the optical fiber corresponding to a transmission destination of the information.

Further, the transmission/reception unit 121a acquires the optical signal transmitted from the other land stations 12b to 12c from the optical fiber corresponding to a transmission source of the optical signal.

The branching apparatus control unit 122a controls the switch circuit S1a, the switch circuit S2a, and the switch circuit S3a included in the branching apparatus 11a descried above. The branching apparatus control unit 122a may be implemented by, for example, a processor such as a Central Processing Unit (CPU), a work memory, and a non-volatile storage device storing a program. This program may be a program for causing the CPU or GPU to execute the control described above.

For example, the branching apparatus control unit 122a may control the switch circuit S1a, the switch circuit S2a, and the switch circuit S3a based on the volume of communication between the land stations.

In this case, for example, when the volume of communication between the land station 12a and the land station 12b increases, the branching apparatus control unit 122a increases the percentage of the switch circuit S1a connected to the switch circuit S2a and the percentage of the switch circuit S2a connected to the switch circuit S1a.

By the above configuration, communication resources can be allocated appropriately based on the volume of communication. As a result, the communication speed between the land stations can be maintained.

That is, at least one or more land stations located at the ends of the first and the second trunk submarine cables preferably include a branching apparatus control unit that controls the first, the second, and the third switch circuits.

Further, the branching apparatus control unit 122a may control both or either one of the switch circuits in the branching apparatus 11a included in the trunk submarine cable L1 and the switch circuits in the branching apparatus included in the trunk submarine cable L2.

Note that, although each of the land stations 12a to 12d according to this example embodiment includes a branching apparatus control unit, at least one or more land stations may include the branching apparatus control unit.

In other words, at least one or more land stations located at the ends of the first and the second trunk submarine cables may include a branching apparatus control unit that controls the first, the second, and the third switch circuits.

Further, the branching apparatus control unit 122a may determine whether or not the branch submarine cable L3 is connected to the branching apparatus 11a. When the branching apparatus control unit 122a determines that the branch submarine cable L3 is not connected to the branching apparatus 11a, the branching apparatus control unit 122a may control the switch circuits Sla and S2a so that they are not connected to the switch circuit S3a.

### <Method for Laying a Submarine Cable System>

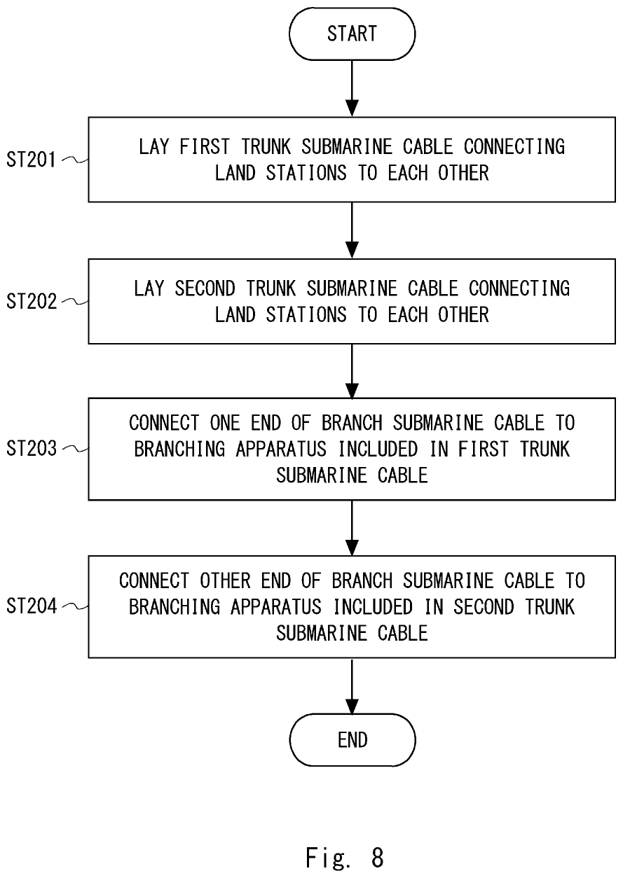

Next, the method for laying a submarine cable according to this example embodiment will be described with reference to FIG. 8. Note that in the following description, FIG. 3 is also referred to as appropriate.

First, the first trunk submarine cable L1 that connects the land stations to each other is laid (Step ST201). More specifically, the trunk submarine cable L1 including the branching apparatus 11a to which the branch submarine cable L3 is not connected is laid at the bottom of the sea.

Next, the second trunk submarine cable L2 that connects the land stations to each other is laid (Step ST202). More specifically, the trunk submarine cable L2 including the branching apparatus 11b to which the branch submarine cable L3 is not connected is laid at the bottom of the sea.

Note that the order in which Steps ST201 and ST202 are executed may be reversed. Further, Steps ST201 and ST202 may be executed in parallel.

Note that after the execution of Steps ST201 and ST202, the trunk submarine cables L1 and L2 may start communication by optical signals independently of each other. That is, communication between the land stations 12a and 12b and communication between the land stations 12c and 12d may be started before the trunk submarine cables L1 and L2 are connected to each other.

In other words, Step ST203 and subsequent Steps may be executed after the trunk submarine cables L1 and L2 start communication by optical signals.

Further, Step ST203 and subsequent Steps may be interrupted until it becomes necessary to connect the trunk submarine cables L1 and L2 to each other.

Note that, from the time Steps ST201 and ST202 are executed to the time Steps ST203 and ST204, which will be described later, are executed, regarding the submarine cables for connection included in the branching apparatuses 11a and 11b, cables or the like are not being connected to the ends thereof that are not connected to the main bodies of the branching apparatuses.

Therefore, from the time Steps ST201 and ST202 are executed to the time Steps ST203 and ST204, which will be described later, are executed, the end of the submarine cable for connection is provided with a waterproof mechanism for protecting it from sea water.

Next, one end of the branch submarine cable is connected to the branching apparatus included in the first trunk submarine cable (Step ST203). More specifically, in Step ST203, the branch submarine cable L3 is connected to the branching apparatus 11a.

Even more specifically, in Step ST203, the end of the cable for connection extending from the branching apparatus 11a is first pulled up onto a working ship. Then, the end of the cable for connection pulled up and one end of the branch submarine cable are connected to each other and laid at the bottom of the sea.

Lastly, the other end of the branch submarine cable is connected to the branching apparatus included in the second trunk submarine cable (Step ST204). In this way, the method for laying a submarine cable according to this example embodiment is completed. More specifically, in Step ST204, the branch submarine cable L3 is connected to the branching apparatus 11b.

Even more specifically, in Step ST204, the end of the cable for connection extending from the branching apparatus 11b is first pulled up onto a working ship. Then, the end of the cable for connection pulled up and the other end of the branch submarine cable are connected to each other and laid at the bottom of the sea.

Note that the order in which Steps ST203 and ST204 are executed may be reversed. Further, Steps ST203 and ST204 may be executed in parallel.

As described above, in the method for laying a submarine cable according to this example embodiment, the trunk submarine cables L1 and L2, each of which includes a branching apparatus to which a branch submarine cable is not connected, are laid. After the trunk submarine cables L1 and L2 are laid, they are connected to each other by the branch submarine cable L3.

By the above configuration, the trunk submarine cables can be connected to each other in response to a change in communication demand, and thus the construction of the submarine cable system can be made to be more adaptable.

### Other Example Embodiments

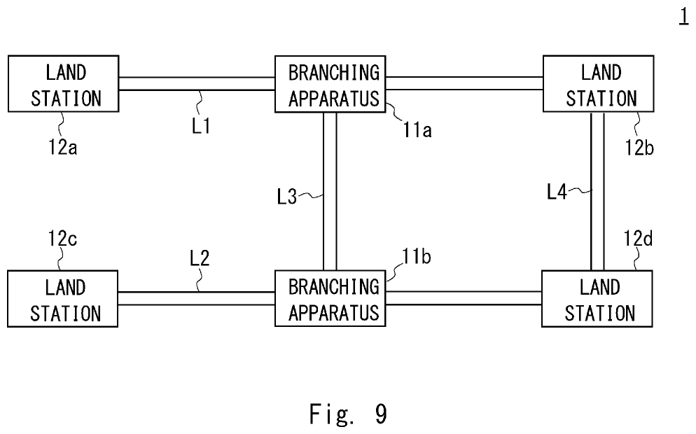

A configuration of the submarine cable system 1 laid by a method for laying a submarine cable will be described in detail with reference to FIG. 9. FIG. 9 is a schematic overhead view showing another configuration example of the submarine cable system according to the present disclosure.

The submarine cable system 1 shown in FIG. 9 differs from that according to the second example embodiment in that the second land station 12b is connected to the fourth land station 12d through a land transmission line L4.

That is, in the submarine cable system shown in FIG. 9, the second land station 12b located at one end of the first trunk submarine cable L1 is connected to the fourth land station 12d located at one end of the second trunk submarine cable L2 through a land communication line.

By the above configuration, for example, even when the branch submarine cable L3 is damaged, the connection established between the trunk submarine cables L1 and L2 can be maintained.

The method for laying a submarine cable system according to the present disclosure may also be applied to the above-described method for laying a submarine cable system.

Further, in the submarine cable system according to the second example embodiment, when it is no longer required to connect the trunk submarine cables L1 and L2 to each other, the branch submarine cable L3 may be disconnected from the branching apparatuses 11a and 11b and then the branch submarine cable L3 may be retrieved.

Further, in the submarine cable system according to the second example embodiment, when it is no longer required to connect the trunk submarine cables L1 and L2 to each other, one end of the branch submarine cable L3 may be disconnected from the corresponding branching apparatus 11a or 11b. Then, the end of the branch submarine cable disconnected from the branching apparatus may be connected to the branching apparatus inserted into a trunk submarine cable other than the trunk submarine cables L1 and L2.

Note that the method for laying a submarine cable system according to the present disclosure is understood as being a method for manufacturing a submarine cable system.

The program includes instructions (or software codes) that, when loaded into a computer, cause the computer to perform one or more of the functions described in the example embodiments. The program may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disc (DVD), Blu-ray disc or other optical disc storage, magnetic cassettes, magnetic tape, magnetic disk storage or other magnetic storage devices. The program may be transmitted on a transitory computer readable medium or a communication medium. By way of example, and not limitation, transitory computer readable media or communication media can include electrical, optical, acoustical, or other form of propagated signals.

Although the present disclosure has been described above with reference to the above example embodiments, the present disclosure is not limited only to the configurations of the above-described example embodiments, and obviously includes various modifications, changes, and combinations that can be made by a person skilled in the art within the scope of the claims of the present application.

The first and second example embodiments and the other embodiment can be combined as desirable by one of ordinary skill in the art.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

While the disclosure has been particularly shown and described with reference to example embodiments thereof, the disclosure is not limited to these embodiments. It will be understood by those of ordinary skill in the art that various changes in form and details may be made therein without departing from the spirit and scope of the present disclosure as defined by the claims.

According to the present disclosure, it is possible to provide a method for laying a submarine cable system in which the construction of the submarine cable system is highly adaptable.

The whole or part of the example embodiments disclosed above can be described as, but not limited to, the following supplementary notes.

### (Supplementary Note 1)

A method for laying a submarine cable system, the method comprising:
laying a first trunk submarine cable comprising a first branching apparatus to which a branch submarine cable is not connected and a second trunk submarine cable comprising a second branching apparatus to which the branch submarine cable is not connected at a bottom of the sea;
connecting one end of the branch submarine cable to the first branching apparatus; and
connecting an other end of the branch submarine cable to the second branching apparatus.

### (Supplementary Note 2)

The method according to supplementary note 1, wherein
the first branching apparatus comprises:
   a first switch circuit connected to one side of the first trunk submarine cable;
   a second switch circuit connected to an other side of the first trunk submarine cable; and
   a third switch circuit connected to the branch submarine cable,
   wherein each of the first, the second, and the third switch circuits is switchably connected to one of the two other switch circuits so that they are brought into one of the following states: a state in which the first switch circuit is connected to the second switch circuit; a state in which the first switch circuit is connected to the third switch circuit; and a state in which the second switch circuit is connected to the third switch circuit, and
the second branching apparatus comprises:
   a fourth switch circuit connected to one side of the second trunk submarine cable;
   a fifth switch circuit connected to an other side of the second trunk submarine cable; and
   a sixth switch circuit connected to the branch submarine cable, and
   wherein each of the fourth, the fifth, and the sixth switch circuits is switchably connected to one of the two other switch circuits so that they are brought into one of the following states: a state in which the fourth switch circuit is connected to the fifth switch circuit; a state in which the fourth switch circuit is connected to the sixth switch circuit; and a state in which the fifth switch circuit is connected to the sixth switch circuit.

### (Supplementary Note 3)

The method according to supplementary note 2, wherein a first land station located in the first trunk submarine cable comprises:
at least one memory storing instructions; and
at least one processor configured to execute the instructions to control the first, the second, and the third switch circuits.

### (Supplementary Note 4)

The method according to supplementary note 2, wherein at least one of the first land station located in the first trunk submarine cable and a second land station located at an end of the second trunk submarine cable comprises:
at least one memory storing instructions; and
at least one processor configured to execute the instructions to control the first, the second, the third, the fourth, the fifth, and the sixth switch circuits.

### (Supplementary Note 5)

The method according to any one of supplementary notes 1 to 4, wherein the first land station located at one end of the first trunk submarine cable and the second land station located at one end of the second trunk submarine cable are connected through a land communication line.

What is claimed is:

1. A method for laying a submarine cable system, the method comprising:
laying a first trunk submarine cable comprising a first branching apparatus to which a branch submarine cable is not connected and a second trunk submarine cable comprising a second branching apparatus to which the branch submarine cable is not connected at a bottom of the sea;
connecting one end of the branch submarine cable to the first branching apparatus; and
connecting an other end of the branch submarine cable to the second branching apparatus.

2. The method according to claim 1, wherein
the first branching apparatus comprises:
a first switch circuit connected to one side of the first trunk submarine cable;
a second switch circuit connected to an other side of the first trunk submarine cable; and
a third switch circuit connected to the branch submarine cable,
wherein each of the first, the second, and the third switch circuits is switchably connected to one of the two other switch circuits so that they are brought into one of the following states: a state in which the first switch circuit is connected to the second switch circuit; a state in which the first switch circuit is connected to the third switch circuit; and a state in which the second switch circuit is connected to the third switch circuit, and
the second branching apparatus comprises:
a fourth switch circuit connected to one side of the second trunk submarine cable;
a fifth switch circuit connected to an other side of the second trunk submarine cable; and
a sixth switch circuit connected to the branch submarine cable, and
wherein each of the fourth, the fifth, and the sixth switch circuits is switchably connected to one of the two other switch circuits so that they are brought into one of the following states: a state in which the fourth switch circuit is connected to the fifth switch circuit; a state in which the fourth switch circuit is connected to the sixth switch circuit; and a state in which the fifth switch circuit is connected to the sixth switch circuit.

3. The method according to claim 2, wherein a first land station located in the first trunk submarine cable comprises:
at least one memory storing instructions; and
at least one processor configured to execute the instructions to control the first, the second, and the third switch circuits.

4. The method according to claim 2, wherein at least one of the first land station located in the first trunk submarine cable and a second land station located at an end of the second trunk submarine cable comprises:
at least one memory storing instructions; and
at least one processor configured to execute the instructions to control the first, the second, the third, the fourth, the fifth, and the sixth switch circuits.

5. The method according to claim 1, wherein the first land station located at one end of the first trunk submarine cable and the second land station located at one end of the second trunk submarine cable are connected through a land communication line.

6. The method according to claim 2, wherein the first land station located at one end of the first trunk submarine cable and the second land station located at one end of the second trunk submarine cable are connected through a land communication line.

7. The method according to claim 3, wherein the first land station located at one end of the first trunk submarine cable and the second land station located at one end of the second trunk submarine cable are connected through a land communication line.

8. The method according to claim 4, wherein the first land station located at one end of the first trunk submarine cable and the second land station located at one end of the second trunk submarine cable are connected through a land communication line.
